(19) United States
(12) Patent Application Publication
(10) Pub. No.: US 2024/0419378 A1
(43) Pub. Date: Dec. 19, 2024

(54) INFORMATION DELIVERY SYSTEM AND DELIVERY PROVISION SERVER PROVIDING DELIVERY INFORMATION TO DELIVERY DESTINATION DEVICE

(71) Applicant: BROTHER KOGYO KABUSHIKI KAISHA, Nagoya (JP)

(72) Inventors: Tetsuya OKUNO, Nagoya (JP); Yuka ISHIHARA, Nagoya (JP); Yushi ICHIKAWA, Nagoya (JP); Yutaka TAKIJIRI, Nagoya (JP); Hiroki SUMI, Nagoya (JP); Sohei YAMAMOTO, Koka (JP); Rie KUDO, Nagoya (JP); Ryo MURASE, Ama (JP)

(21) Appl. No.: 18/742,591

(22) Filed: Jun. 13, 2024

(30) Foreign Application Priority Data
Jun. 16, 2023 (JP) 2023-099578

(51) Int. Cl. G06F 3/12

(52) U.S. Cl. CPC G06F 3/1285; G06F 3/1203; G06F 3/1224; G06F 3/1237

(57) ABSTRACT

An information delivery system includes: a delivery destination device; and a delivery provision server. The delivery provision server includes: a memory; and a controller. The controller performs: a request process; a receiving process; and a delivery process. The request process transmits a request for specific delivery information to a delivery management server. The specific delivery information is delivery information satisfying a predetermined condition. The predetermined condition includes a requirement that the delivery information be suited to user information corresponding to user identification information associated with delivery destination identification information by association information stored in the memory. The receiving process receives, in response to the request, the specific delivery information from the delivery management server. The delivery process transmits an output instruction to the delivery destination device corresponding to the delivery destination identification information. The output instruction instructs the delivery destination device to perform output based on the specific delivery information.

### REFERENCE TO RELATED APPLICATIONS

This application claims priority from Japanese Patent Application No. 2023-099578 filed on Jun. 16, 2023. The entire content of the priority application is incorporated herein by reference.

### BACKGROUND ART

A conventional system configured of an advertisement transmission server and a printing device is known in the art. The advertisement transmission server in this system is provided with a customer information database storing personal information on users, and an advertisement database. When a request is received from the printing device, the server identifies the user of the printing device from information included in the request, such as an origination number, address, and the like, and extracts personal information on the identified user from the customer information database.

The extracted personal information includes the user's gender, age, occupation, hobbies, tastes, and the like. The server acquires advertisement data suited to this personal information from the advertisement database and sends the data to the printing device for printing.

### SUMMARY

In the conventional system, personal information like hobbies is registered for the users of printers in advance, and advertisements are printed on the basis of this registered personal information. Consequently, the need to manage hobbies and other registered information for each user of a printer can be cumbersome.

In view of the foregoing, it is an object of the present disclosure to provide an information delivery system, a delivery provision server, and a terminal that are capable of delivering and printing information suited to individual users of printers without having to manage information on each user's preferences, interests, and the like.

In order to attain the above and other object, according to one aspect, the present disclosure provides an information delivery system. The information delivery system includes: a delivery destination device; and a delivery provision server. The delivery provision server includes: a communication interface; a memory; and a controller. The communication interface is configured to receive delivery information from a delivery management server. The delivery management server is configured to manage the delivery information. The memory is configured to store association information associating user identification information with delivery destination identification information. The delivery destination identification information identifies the delivery destination device as a delivery destination of the delivery information. The user identification information identifies a user and is used for the user logging in to a user account for an external service using a terminal device other than the delivery destination device. The controller is configured to perform: a request process; a first receiving process; and a delivery process. The request process transmits a request for specific delivery information to the delivery management server via the communication interface. The specific delivery information is the delivery information satisfying a predetermined condition. The predetermined condition including a requirement that the delivery information be suited to user information corresponding to the user identification information which is associated with the delivery destination identification information by the association information stored in the memory. The first receiving process receives, in response to the request transmitted in the request process, the specific delivery information from the delivery management server via the communication interface. The delivery process transmits an output instruction to the delivery destination device corresponding to the delivery destination identification information via the communication interface. The output instruction instructs the deliver destination device to perform output based on the specific delivery information.

In the above structure, specific delivery information suited to user information is received using user identification information corresponding to delivery destination identification information, and output based on the specific delivery information is performed. According to the present disclosure, delivery information suited to user information for individual users can be outputted without having to manage information on each user's preferences, interests, and the like for each delivery destination device, as is the case with conventional methods.

According to another aspect, the present disclosure also provides a delivery provision server. The deliver provision server includes: a communication interface; a memory; and a controller. The communication interface is configured to receive delivery information from a delivery management server. The delivery management server is configured to manage the delivery information. The memory is configured to store association information associating user identification information with delivery destination identification information. The deliver destination identification information identifies a delivery destination device as a delivery destination of the delivery information. The user identification information identifies a user and is used for the user logging in to a user account for an external service using a terminal device other than the delivery destination device. The controller is configured to perform: a request process; a receiving process; and a delivery process. The request process transmits a request for specific delivery information to the delivery management server via the communication interface. The specific delivery information being the delivery information satisfying a predetermined condition. The predetermined condition includes a requirement that the delivery information be suited to user information corresponding to the user identification information which is associated with the delivery destination identification information by the association information stored in the memory. The receiving process receives, in response to the request transmitted in the request process, the specific delivery information from the delivery management server via the communication interface. The delivery process transmits an output instruction to the delivery destination device corresponding to the delivery destination identification information via the communication interface. The output instruction instructs the delivery destination device to perform output based on the specific delivery information.

According to still another aspect, the present disclosure also provides a delivery provision server. The delivery provision server includes: a memory; a communication interface; and a controller. The communication interface is configured to transmit delivery information to a delivery destination device. The controller is configured to perform: a transmission process; an association process; and a delivery process. The transmission process transmits settings screen information for displaying a settings screen to a terminal device other than the delivery destination device via the communication interface. The settings screen is used for configuring a setting for delivery of the delivery information. The association process stores, in response to an input of a user account for an external service being received through the settings screen displayed on the terminal device, association information associating user identification information corresponding to the user account with delivery destination identification information in the memory. The delivery destination identification information identifies the deliver destination device as a delivery destination of the delivery information. The user identification information identifies a user and is used for the user logging in to the user account for the external service using the terminal device. The deliver process transmits specific delivery information to the delivery destination device corresponding to the delivery destination identification information via the communication interface. The specific delivery information is the delivery information satisfying a predetermined condition. The predetermined condition includes a requirement that the delivery information be suited to user information corresponding to the user identification information which is associated with the delivery destination identification information by the association information stored in the memory.

According to still another aspect, the present disclosure further provides a terminal device. The terminal device includes: a communication interface; a display; and a controller. The communication interface is communicable with a deliver provision server. The delivery provision server is configured to provide delivery information to a delivery destination device. The controller is configured to perform: an acquisition process; a display process; and a reception process. The acquisition process acquires settings screen information for displaying a settings screen from the delivery provision server via the communication interface. The settings screen is used for configuring a setting for delivery of the delivery information. The display process displays on the display the settings screen based on the settings screen information acquired in the acquisition process. The reception process receives an input of a user account for an external service through the settings screen displayed on the display in the display process. The delivery provision server is configured to provide specific delivery information to the delivery destination device. The specific delivery information is the delivery information satisfying a predetermined condition. The predetermined condition includes a requirement that the delivery information be suited to user information corresponding to user identification information. The user identification information identifies a user and is used for the user logging in to the user account for the external service.

### BRIEF DESCRIPTION OF DRAWINGS

FIG. 1 is a block diagram illustrating an example of the overall configuration of an information delivery system including an advertisement provision server, an advertisement management server, a user management server, a terminal device, and a printer.

FIGS. 2A through 2C are explanatory diagrams illustrating an example of the transition of display content on a display unit of the terminal device when processes of registering an external user ID and the like are performed.

FIGS. 3A through 3F are explanatory diagrams illustrating another example of the transition of display content on the display unit of the terminal device when processes of registering an external user ID and the like are performed.

FIGS. 4A and 4B are explanatory diagrams illustrating an example of the transition of display content on the display unit of the terminal device when another user is invited and associated with the printer.

FIGS. 5A through 5C are explanatory diagrams illustrating an example of the transition of display content on the display unit of the terminal device when another user is invited and associated with the printer.

FIG. 6 is a sequence chart illustrating an example of steps in a process executed by the advertisement provision server, the advertisement management server, the user management server, the terminal device, and the printer in cooperation with each other.

FIG. 7 is an explanatory diagram illustrating an example of associations established between printer IDs and external user IDs.

FIG. 8 is an explanatory diagram illustrating an example of associations established between external user IDs and user interest information.

FIG. 9 is an explanatory diagram illustrating an example of correlations between delivery times and days and external user IDs.

FIG. 10 is a flowchart illustrating steps in a delivery image creation process executed by a control unit of the advertisement provision server.

FIGS. 11A through 11C are explanatory diagrams illustrating an example of the transition of display content on the display unit of the terminal device when a user performs operations on the terminal device to issue a delivery blocking request.

FIGS. 12A through 12C are explanatory diagrams illustrating another example of the transition of display content on the display unit of the terminal device and printed matters when the user performs operations on the terminal device to issue the delivery blocking request.

FIGS. 13A through 13H are explanatory diagrams illustrating an example of the transition of display content on the display unit of the terminal device when matching conditions for advertisement delivery are set in advance.

### DESCRIPTION

An embodiment of the present disclosure will be described while referring to the accompanying drawings. In this embodiment, the present disclosure is applied to an information delivery system that delivers advertisement information from a server to printers for printing.

### <Overall Configuration of Information Delivery System>

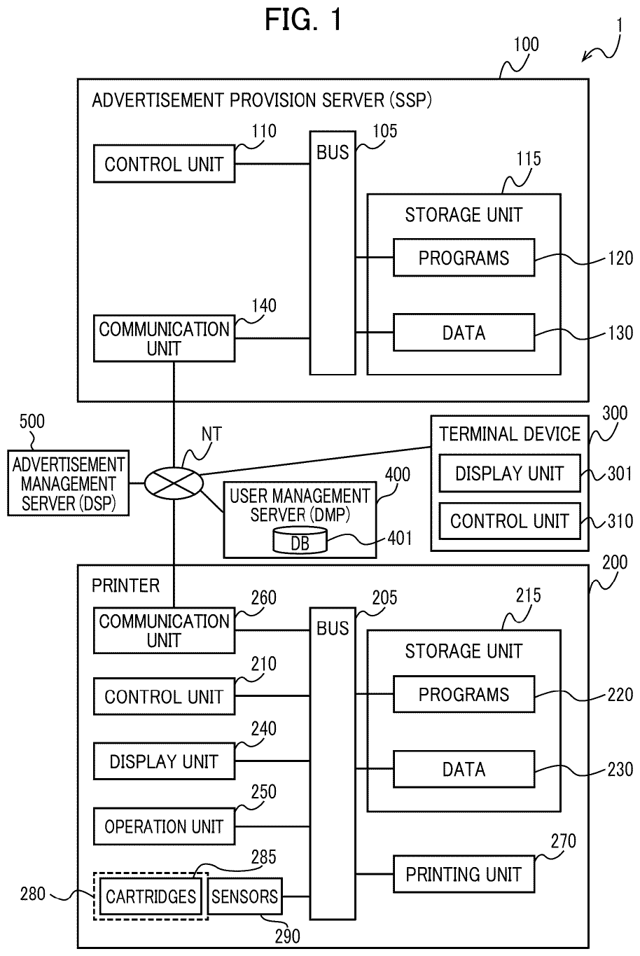

FIG. 1 illustrates an example of the overall configuration of an information delivery system 1 according to the present embodiment. As illustrated in FIG. 1, the information delivery system 1 includes an advertisement provision server (SSP: a supply-side platform) 100, a printer 200, a terminal device 300, a user management server (DMP: a data management platform) 400, and an advertisement management server (DSP: a demand-side platform) 500. The servers 100, 400, and 500, the printer 200, and the terminal device 300 each include a communication unit and can communicate with each other over a network NT. The network NT includes at least one of the Internet, a local area network (LAN), and a wide area network (WAN). The communication unit may be configured to include a plurality of types of communication circuits for connecting to the network NT. In this case, each device connected to the network NT may communicate with a plurality of other devices using different communication circuits. In the present embodiment, the different types of communication circuits are collectively referred to as the communication unit.

### <Terminal Device>

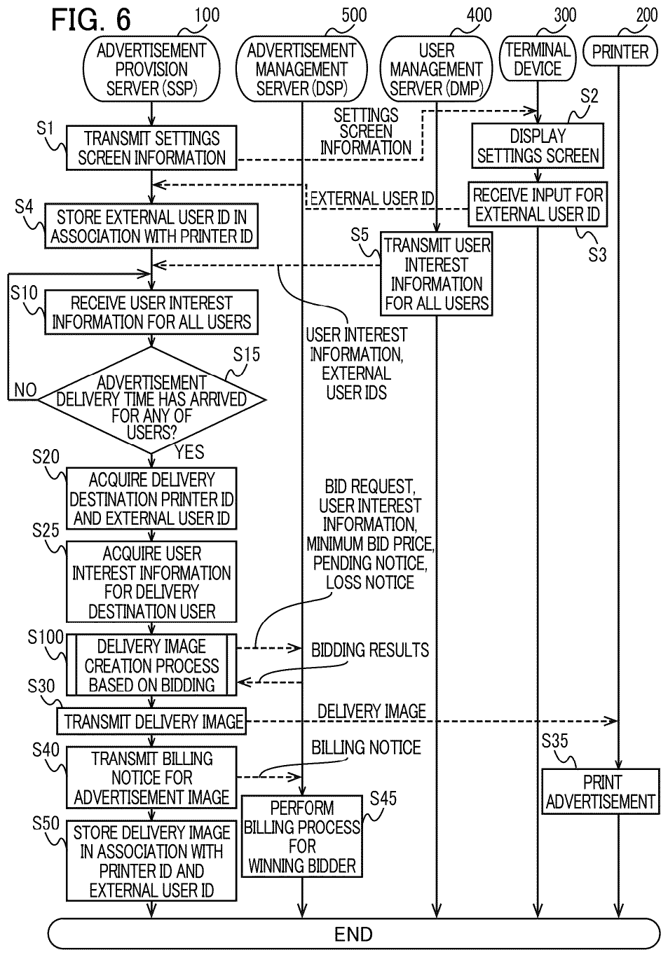

The terminal device 300 is a smartphone or other portable device owned by the user, for example. In this example, the terminal device 300 is connected to the network NT via a wireless connection. In addition to a smartphone, the terminal device 300 may be any suitable terminal separate from the printer 200, such as a tablet computer, a laptop computer, or a desktop computer. Alternatively, the terminal device 300 may be a portable or stationary terminal provided in a karaoke box, any of various types of stores, and the like for selecting songs, selecting items from menus, or browsing products, for example. The terminal device 300 is an example of the terminal device of the present disclosure. The terminal device 300 includes a display unit 301 and a control unit 310. While not illustrated in the drawings, the terminal device 300 also includes an operation unit, a storage unit, a communication unit, and the like. The storage unit stores various programs. In the terminal device 300, the storage unit is an example of the memory of the present disclosure, the communication unit is an example of the communication interface of the present disclosure, the control unit 310 is an example of the controller of the present disclosure, such as a CPU, and the display unit 301 is an example of the display of the present disclosure. The control unit 310 executes the various programs stored in the storage unit. These programs include a program for implementing the process illustrated in the flowchart of FIG. 6 described later.

The display unit 301 is configured of a touchscreen that also serves as an operation unit by a touchpad integrally combined with a liquid crystal display, for example. The display unit 301 displays various information and receives various input operations from the user.

The user can input various instructions into the terminal device 300 by operating the touch screen. The user can also receive external services from outside the system via the Internet through operations on the touchscreen. Examples of external services may be services that are available using prescribed terminals other than the printer 200 and that provide user information held in association with a user ID for advertising targeting. Specifically, external services are provided by entities different from the vendor of the printer 200, such as payment service providers of QR code (registered trademark) payments and credit card payments, ad network providers, advertisement platform providers, social media providers including E-commerce mall operators and SNS retailers, service providers providing services through various application programs (apps), service providers of transportation IC cards and the like, ridesharing service providers such as taxi apps and food delivery services, online travel agents (OTA) and other service providers that possess user identification information and user attribute/behavioral information and use this information for programmatic advertising (web advertising and social media advertising). “QR code” is a Japanese registered trademark of DENSO WAVE INCORPORATED. External services may also be services other than printer-based services. Each user is assigned an external user ID as identification information unique to the user when the user receives any of various external services. As will be described later, the external user ID is transmitted to the advertisement provision server 100 to be associated with a printer 200 designated by the user, e.g., the printer ID of the printer 200 used by this user. The external user ID is an example of the user identification information of the present disclosure. The advertisement provision server 100 stores these external user IDs and printer IDs as association information.

### <User Management Server>

The user management server 400 manages information on the user (user information) that is acquired and updated via the terminal device 300. Though not illustrated in the drawings, the user management server 400 includes a control unit, a storage unit, a communication unit, and the like. Examples of user information managed by the user management server 400 include the user's gender, age, place of residence, occupation, place of work, annual income, family structure, or behavioral information. Examples of behavioral information include the user's website browsing history, website search history, web advertisement display history, website click history, website purchase history, payment amount information, visited stores information, and GPS information when accessing the aforementioned external services using the terminal device 300. The user's behavioral information is associated with the external user ID of that user and can be identified by the external user ID. The behavioral information for all users who employs external services is stored in a behavioral information database 401 in the storage unit. In the behavioral information database 401, the behavioral information for each user is associated with the external user ID of the user. The behavioral information is an example of the user behavioral information of the present disclosure.

In the present embodiment, behavioral information that has been associated with the external user ID of each user is further converted and compiled into a form of corresponding user interest information. The user interest information specifies items of interest to the user. The items of interest to users have been preset in association with the contents of the above behavioral information. Examples of the items of interest include “cars,” “health,” “travel,” “food,” “saving money,” and the like. The user interest information may also include information specifying the location of the user (e.g., “Tokyo”) inferred from the content of the behavioral information for the user. In the case of a middle-aged male user, for example, the external user ID may be associated with “cars,” “health,” and the like based on the user's browsing history and other behavioral information. In the case of a female user in her 20s, for example, the external user ID may be associated with “travel,” “food,” and the like based on the user's browsing history and other behavioral information. When the user is a male high school student, for example, the external user ID may be associated with “cars,” “saving money,” and the like based on the user's browsing history and other behavioral information. The user interest information associated with each external user ID in this way is transmitted to the advertisement provision server 100 via the communication unit.

### <Advertisement Provision Server>

The advertisement provision server 100 is installed and managed by the manufacturer of the printer 200, for example. At prescribed timings, the advertisement provision server 100 acquires the user interest information corresponding to the external user ID that has been associated with the printer ID of the printer 200 that is the destination of delivery, and receives to acquire advertisement images tailored to this user interest information from the advertisement management server 500. The advertisement provision server 100 then delivers the acquired advertisement images to the printer 200 for printing. The advertisement provision server is an example of the delivery provision server of the present disclosure, and the advertisement images are examples of the delivery information of the present disclosure.

More specifically, the advertisement provision server 100 includes a control unit 110, a storage unit 115, and a communication unit 140. The control unit 110 is an example of the controller of the present disclosure. The communication unit 140 is an example of the communication interface of the present disclosure. The storage unit 115 is an example of the memory of the present disclosure. The control unit 110, storage unit 115, communication unit 140, and the like are connected via a bus 105 and can exchange information with each other. The storage unit 115 is configured of RAM, ROM, EEPROM, a hard disk drive, and the like, for example. The storage unit 115 stores various programs 120, and various data 130. The programs 120 include an information delivery program for controlling the advertisement provision server 100 to implement a control process according to the flowchart of FIG. 6 described later. The data 130 includes the user interest information described above, the printer ID of the printer 200, external user IDs, and advertisement images. This printer ID is associated with the external user ID for all users that use the printer 200. Note that the printer 200 is used by at least one user.

The control unit 110 is a device, such as a CPU or other processor, that performs data processing. The control unit 110 executes the various programs stored in the storage unit 115. The control unit 110 implements various processes including data communications with the printer 200, terminal device 300, user management server 400, and advertisement management server 500 which are connected to the network NT. The communication unit 140 is connected to the network NT and facilitates communications between the advertisement provision server 100 and the printer 200, terminal device 300, user management server 400, and advertisement management server 500.

### <Advertisement Management Server>

The advertisement management server 500 transmits advertisement images to be printed by the printer 200 to the advertisement provision server 100. While not illustrated in the drawings, the advertisement management server 500 includes a control unit, a storage unit, and a communication unit. In this example, the advertisement management server 500 receives a bid request from the advertisement provision server 100 via the communication unit. Note that the bid request is a request to acquire suitable advertisement images through a bidding process. The terminal devices or servers (not illustrated) of a plurality of advertisers are connected to the network NT. The control unit of the advertisement management server 500 holds an auction for delivery of advertisement images that are to be submitted along with bids from these advertisers in response to the above bid request and obtains an advertisement image suited to the user interest information through bids from the participating advertisers. The advertisement management server 500 may acquire the behavioral information directly from the user management server 400 or indirectly via the advertisement provision server 100, instead of the user interest information, and may acquire an advertisement image suited to this behavioral information through bids in the auction. When there is a winning bid that meets predetermined conditions of the auction, the control unit of the advertisement management server 500 acquires the corresponding advertisement image from the terminal device or the like of the advertiser who is the winning bidder. After acquiring this advertisement image, the advertisement management server 500 transmits this advertisement image to the advertisement provision server 100 via the communication unit, the advertisement provision server 100 transfers the advertisement image to the printer 200, and the printer 200 performs printing based on the advertisement image. Alternatively, the advertisement provision server 100 may be configured to acquire the above advertisement image from the advertisement management server 500, or the advertisement management server 500 may acquire the advertisement image from another external server and may transmit this advertisement image to the advertisement provision server 100. The advertisement management server 500 is an example of the delivery management server of the present disclosure.

The servers 100, 400, and 500 may each be configured as a standalone server or may be each be configured of a cluster of multiple servers. Alternatively, a single standalone server may be provided with the functions of two or more of the servers 100, 400, and 500.

### <Printer>

The printer 200 is assigned the printer ID described above. The printer 200 is an example of the delivery destination device and the printer of the present disclosure, and the printer ID is an example of the delivery destination identification information and the printer identification information of the present disclosure. The printer 200 includes a control unit 210, a storage unit 215, a display unit 240, an operation unit 250, a communication unit 260, and a printing unit 270. The control unit 210, storage unit 215, display unit 240, operation unit 250, communication unit 260, and printing unit 270 are interconnected via a bus 205 and can exchange information with each other.

The storage unit 215 is configured of RAM, ROM, EEPROM, and a hard disk drive, for example. The storage unit 215 stores various programs 220, and various data 230. The programs 220 include a program for controlling the printer 200 to implement the control process according to the flowchart of FIG. 6 described later, for example. The data 230 includes the printer ID described above, and advertisement images received from the advertisement provision server 100, that is, advertisement images that have been acquired from the terminal devices or the like of winning bidders from among advertisers participating in auctions and relayed by the advertisement provision server 100. In addition to the above information, the storage unit 215 may store other information on the printer 200 including performance information related to monochrome/color printing, specification information, intended use information such as whether the printer is intended for home use or office use, and destination information indicating the intended country of use. The storage unit 215 may also store the number of sheets printed by the printing unit 270 and the like. At least some of the various data described above may be stored in the storage unit 115 of the advertisement provision server 100. Alternatively, at least some of the data, which is original data, may be stored in one of the storage unit 215 of the printer 200 and the storage unit 115 of the advertisement provision server 100, and duplicate data of this original data may be stored in the other storage unit.

The control unit 210 is a device, such as a CPU or other processor, that performs data processing. The control unit 210 executes the various programs stored in the storage unit 215. The display unit 240 is a liquid crystal display, for example, that can display various information. The operation unit 250 is configured of a keyboard and buttons, for example, and receives input operations from the user. By operating the operation unit 250, the user can input various instructions into the printer 200. The communication unit 260 is connected to the network NT and facilitates communications between the printer 200 and the advertisement provision server 100, advertisement management server 500, user management server 400, and terminal device 300. The printing unit 270 includes a printing engine. The printing unit 270 performs printing by forming an image on a sheet of printing paper according to the inkjet method while feeding and conveying the sheet from a paper tray with a conveying mechanism (not illustrated), for example. The sheet of printing paper is an example of the sheet of the present disclosure.

The printer 200 also includes a cartridge holder 280. The cartridge holder 280 can accommodate a plurality of cartridges 285. The cartridges 285 include cartridges for a plurality of ink colors, including cyan, magenta, yellow, and black, for example. The cartridge holder 280 includes ink level sensors (not illustrated) that can detect the residual quantities or consumed quantities of ink in the respective cartridges 285 according to a known method.

The printing unit 270 performs printing processes while consuming ink from the cartridges 285. The cartridge holder 280 also includes cartridge sensors 290. Each cartridge sensor 290 reads cartridge information from and writes cartridge information to an IC chip provided on the corresponding one of the cartridges 285 accommodated in the cartridge holder 280. The cartridge sensor 290 detects the type and the like of the corresponding cartridge 285 accommodated in the cartridge holder 280 by reading cartridge information from the corresponding IC chip, for example. The cartridge sensor 290 may also detect a used amount or residual amount of ink in the cartridge 285 by reading the IC chip.

### First Feature of the Embodiment

As described above, one feature of the present embodiment is that the advertisement provision server 100 acquires user interest information linked to an external user ID of a user of the printer 200, and delivers to the printer 200 an advertisement image received from the advertisement management server 500 that is tailored to the user interest information corresponding to the external user ID associated with the printer ID of the printer 200 that is the destination of deliver. A step-by-step description of this process will be given below.

### <Registration of External User IDs>

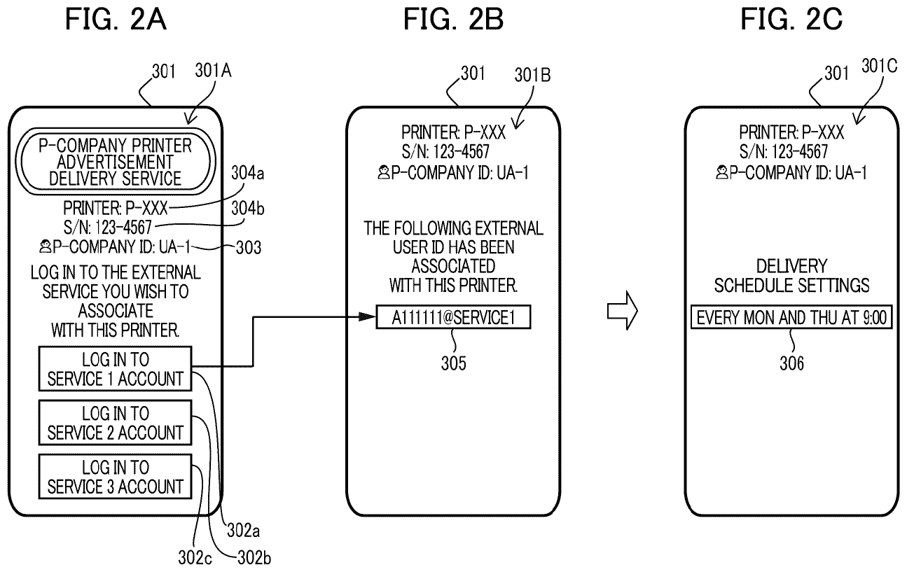

First, in the present embodiment, a user registers an external user ID through input operations on the terminal device 300. For example, when the user performs an appropriate operation in a browser running on the terminal device 300, the terminal device 300 accesses the advertisement provision server 100 and acquires and displays a web page of the advertisement delivery service. When the user logs in to the web page through input operations on the terminal device 300, the terminal device 300 displays a settings screen 301A illustrated in FIG. 2A on the display unit 301.

In this example, the settings screen 301A includes a model number 304a for the printer 200, a serial number 304b, and a user ID 303. The model number 304a is “P-XXX” in this example. The serial number 304b is the printer ID for the printer 200 and is set to “123-4567” in this example. The user ID 303 is used to access this advertisement delivery service and is “UA-1” in this example. Thus, the printer ID for the printer 200 normally used by user “UA-1” is preset to “123-4567” in the above advertisement delivery service.

The example in FIG. 2A shows three external services that can be associated with the printer 200: Service 1, Service 2, and Service 3. To access any of these external services, the user must log in using the external user ID registered with the corresponding external service. For this reason, the settings screen 301A displays the message “Log in to the external service you wish to link to this printer”; and a “Log in to Service 1 account” button 302a, a “Log in to Service 2 account” button 302b, and a “Log in to Service 3 account” button 302c as login buttons for the three external services. In this example, user “UA-1” is selecting the login button for an external service with which the user has registered an external user ID.

When the user operates the “Log in to Service 1 account” button 302a, for example, a login screen from the website of Service 1 is displayed on the display unit 301. In this example, the account held by user “UA-1” for using Service 1 has the external user ID “A111111@Service1”. When the user logs in with this external user ID, the advertisement provision server 100 acquires the external user ID and associates the external user ID with the printer ID “123-4567”. As a result of this process, the display on the display unit 301 shifts to a settings screen 301B illustrated in FIG. 2B. The settings screen 301B displays the message “The following external user ID has been associated with this printer,” and an external user ID display field 305 in which the external user ID “A111111@Service1” has been entered. Similar screens are displayed when the user operates the “Log in to Service 2 account” button 302b and “Log in to Service 3 account” button 302c. Hereinafter, these buttons 302a, 302b, and 302c will simply be referred to as “login buttons 302.”

The provider of the advertisement delivery service may select an external service provider as a collaborator for each of Services 1, 2, and 3 described above, and the buttons 302a, 302b, and 302c may be the login buttons to external services of the collaborators and may be displayed in the settings screen 301A as the default. When the user is already using the service associated with one of the login buttons, the display shifts to a login screen for the website of that external service when the user operates the login button. After the user has logged in to the login screen using the external user ID, the advertisement provision server 100 acquires this external user ID and performs the above process for associating this external user ID with the printer ID. Subsequently, the display on the display unit 301 shifts to the settings screen 301B.

If the user operates a login button but is not actually using the service associated with the login button, a suitable error screen or error message is displayed. That is, if the user is not using the service associated with the login button, the user does not possess a login user ID or password for that service. Consequently, when the user operates this login button, the terminal device 300 displays a suitable error screen or error message, such as “The login has failed due to incorrect authentication information. The user cannot be associated with this printer.” or “A login was attempted using invalid authentication information.”

After completing registration through the process of associating the printer ID with the external user ID as illustrated in FIG. 2B, the user performs an appropriate operation on the terminal device 300 to display a settings screen 301C illustrated in FIG. 2C on the display unit 301. In the settings screen 301C, the user can set up an advertisement delivery schedule. The settings screen 301C in this example includes a scheduling field 306 in which the user can specify times and days of the weeks for advertisement delivery by performing suitable operations on the terminal device 300. Here, user “UA-1” has set advertisement delivery to be every Monday and Thursday at 9:00. The days of the week and time inputted into the settings screen 301C are stored in the storage unit 115 of the advertisement provision server 100 in association with the external user ID.

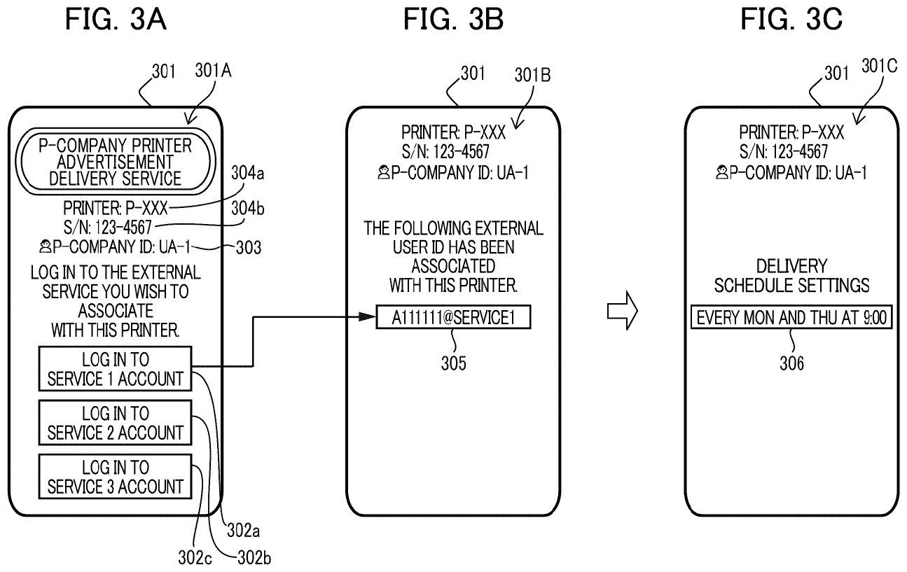

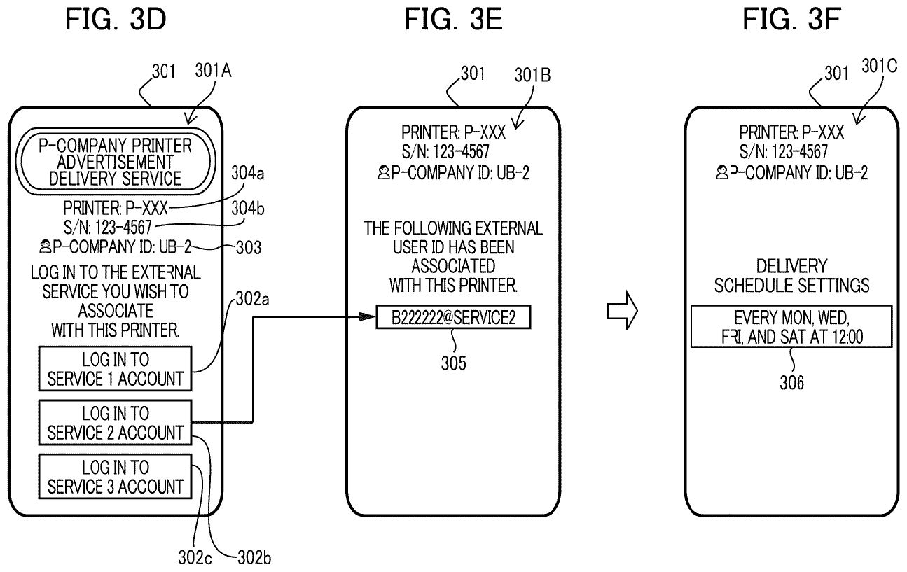

FIGS. 3A-3F show an example in which one printer 200 is used by a plurality of users. In this example, the printer 200 having printer ID “123-4567” is used by two people: the above user “UA-1” and a separate user “UB-2”. That is, the terminal device 300 owned by user “UA-1” displays each of the settings screens 301A, 301B, and 301C illustrated in FIGS. 3A-3C, which are identical to those in FIGS. 2A-2C and performs the same process according to the operations described above.

The terminal device 300 owned by user “UB-2” also performs the same process in the settings screens 301A, 301B, and 301C, as shown in FIGS. 3D-3F, which are similar to FIGS. 2A-2C. In other words, user “UB-2” performs operations to log in to the advertisement delivery service, displaying the settings screen 301A illustrated in FIG. 3D on the display unit 301. As described above, the printer ID for the printer 200 normally used by user “UB-2” is preset to “123-4567” in the advertisement delivery service. In accordance with user “UB-2” using Services 1, 2, and 3 as external services, the “Log in to Service 1 account” button 302a, “Log in to Service 2 account” button 302b, and “Log in to Service 3 account” button 302c are displayed in the settings screen 301A as login buttons.

When user “UB-2” operates the “Log in to Service 2 account” button 302b, for example, the external user ID “B222222@Service2” possessed by user “UB-2” for Service 2 is acquired as described above and is associated with the printer ID “123-4567,” as illustrated in the settings screen 301B of FIG. 3E. After the display shifts to the settings screen 301C illustrated in FIG. 3F, user “UB-2” performs operations in the settings screen 301C to set a delivery schedule for advertisements. In this case, user “UB-2” has set advertisement delivery to every Monday, Wednesday, Friday, and Saturday at 12:00.

When a single printer 200 is shared by a plurality of users, as described above, the users are not limited to logging in to the advertisement delivery service using their own terminal devices 300 to perform various settings for themselves. That is, a specific user may be authorized to perform various settings on behalf of the other users, such as associating external user IDs with the printer ID, setting up schedules, and the like, while the specific user is logged in to the advertisement delivery service.

Alternatively, the specific user may transmit an invitation to the other users by email or the like while logged in to the advertisement delivery service, and the other users who receive this invitation may perform their own various settings while logged in to the advertisement delivery service.

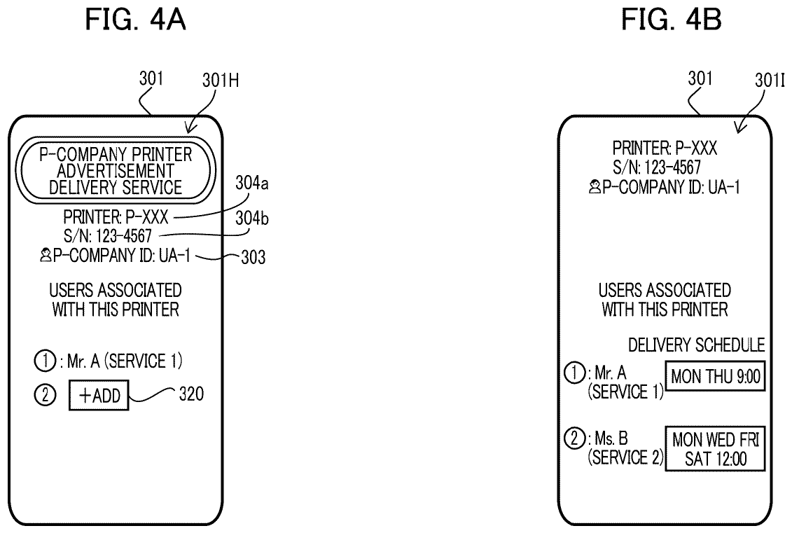

For example, if the external user ID that user “UA-1” uses for accessing Service 1 has been associated with the printer 200 having printer ID “123-4567” by user “UA-1”, the terminal device 300 displays a user invitation screen 301H illustrated in FIG. 4A on the display unit 301 after the user “UA-1” logs in to the advertisement delivery service. At this time, the terminal device 300 displays the name of user “UA-1” (“Mr. A” in this example) in the user invitation screen 301H as the user associated with the printer and includes an “Add” button 320 in the user invitation screen 301H. When the user operates the “Add” button 320 in this example, an invitation email containing a URL is sent to the email address of user “UB-2”, who also uses the printer 200.

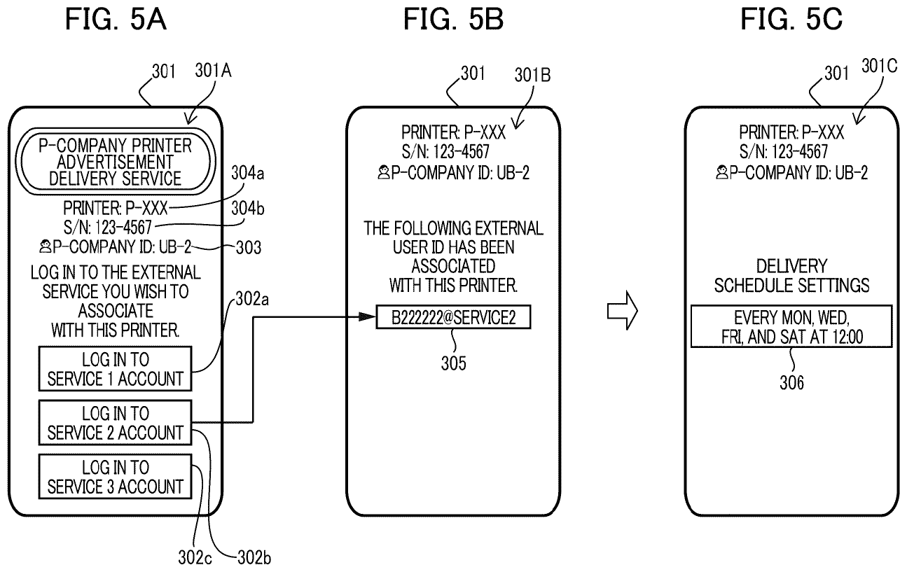

After receiving the above invitation email, user “UB-2” accesses the URL included in the email with the user's own terminal device 300 and logs in to the advertisement delivery service. At this time, the terminal device 300 displays the settings screens 301A, 301B, and 301C illustrated in FIGS. 5A, 5B, and 5C, which are identical to those in FIGS. 3D, 3E, and 3F described above, and performs the same process described for FIGS. 3D, 3E, and 3F. As a result, the terminal device 300 displays a user management screen 301I illustrated in FIG. 4B on the display unit 301 of the terminal device 300 for user “UA-1” who sent the invitation described above. The user management screen 301I displays the name “Mr. A” of user “UA-1” together with the name “Ms. B” for user “UB-2” as users associated with this printer. In this example, the user management screen 301I also displays the advertisement delivery schedule settings for each user, i.e., delivery settings indicating every Monday and Thursday at 9:00 for user “UA-1” and every Monday, Wednesday, Friday, and Saturday at 12:00 for user “UB-2”.

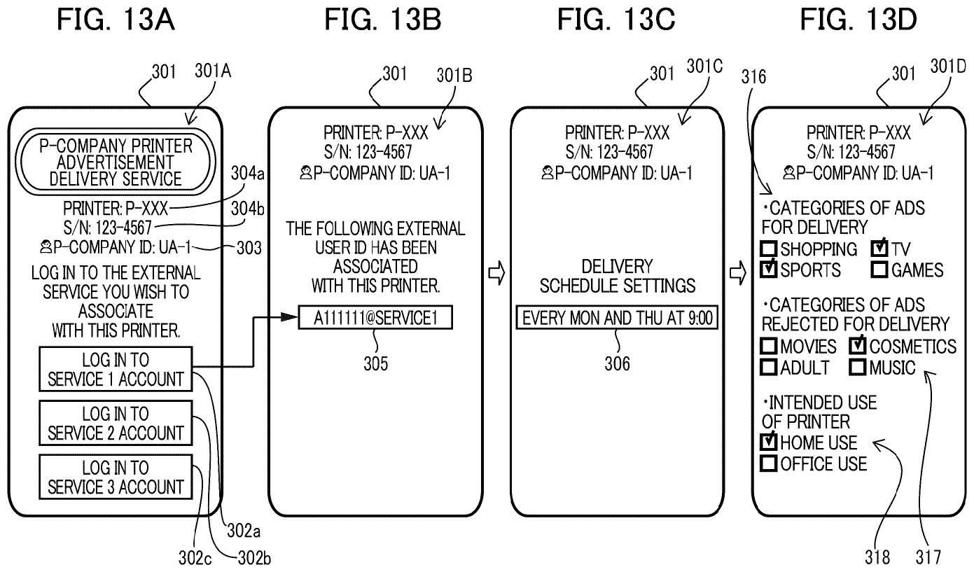

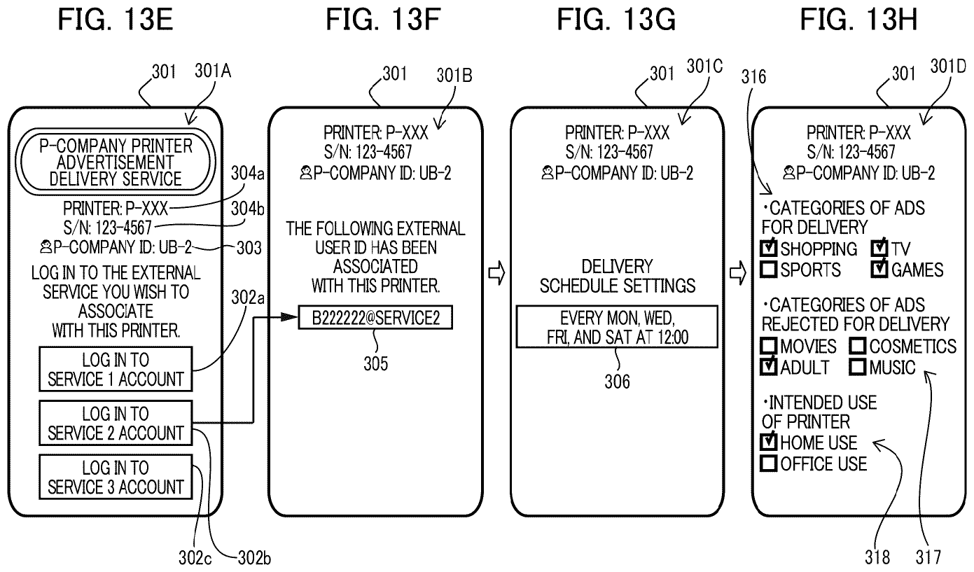

As described above, settings screens 301A, 301B, 301C, 301H, and 301I are used to configure delivery settings for delivering advertisement images to the printer 200. This also applies to a settings screen 301D illustrated in FIGS. 13G and 13H of a modification described later with reference to FIGS. 13A-13H.

### <Process Flow>

After registering an external user ID as described above, the advertisement provision server 100 of the information delivery system 1 acquires user interest information as described above and delivers advertisement images tailored to the user interest information to the printer 200. Here, the control sequence executed through cooperation among the advertisement provision server 100, advertisement management server 500, user management server 400, printer 200, and terminal device 300 to implement a series of processes including the registration of external user IDs will be described with reference to the sequence chart of FIG. 6.

When the terminal device 300 requests a web page screen from the advertisement provision server 100 in response to specific user operations on the terminal device 300, for example, in S1 of FIG. 6 the advertisement provision server 100 generates settings screen information for displaying the settings screen 301A described above on the display unit 301 of the terminal device 300 and transmits this settings screen information to the terminal device 300. At this time, the process executed by the advertisement provision server 100 is an example of the transmission process of the present disclosure. The terminal device 300 receives the settings screen information transmitted from the advertisement provision server 100. At this time, the process executed by the terminal device 300 is an example of the acquisition process of the present disclosure.

In S2 the terminal device 300 displays the settings screens 301A-301C illustrated in FIGS. 2A-2C as needed. At this time, the process executed by the terminal device 300 is an example of the display process of the present disclosure. When the user operates one of the login buttons 302 described above in the settings screen 301A at this time, the advertisement provision server 100 requests cooperation from the external service server, i.e., the server providing the selected external service, in conformance with a protocol such as “OAuth 2.0”. Upon receiving this request, the external service server displays a login screen (not illustrated) on the display unit 301 of the terminal device 300. In S3 the terminal device 300 receives user input for the external user ID in the login screen and logs in to the external service. The process of S3 executed by the terminal device 300 is an example of the reception process of the present disclosure. Once the terminal device 300 has completed logging in to the external service, the external service server transmits the external user ID to the advertisement provision server 100, and the advertisement provision server 100 acquires this external user ID.

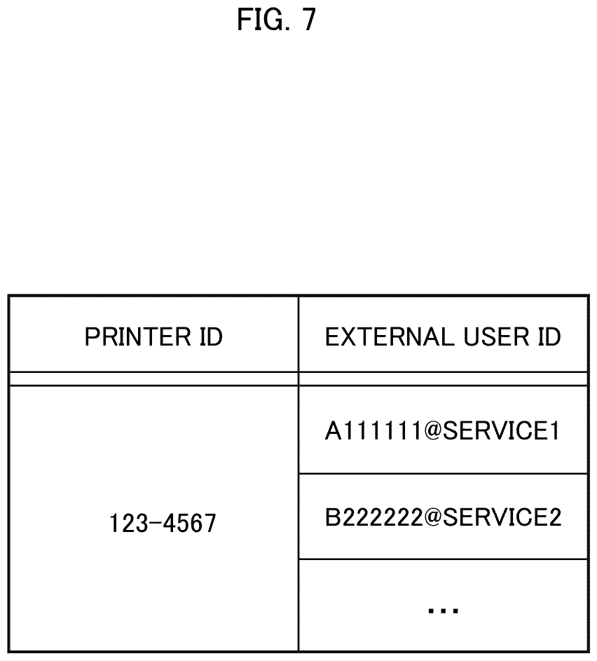

In S4 the advertisement provision server 100 stores the external user ID acquired from the external service server in the storage unit 115 in association with the printer ID for the printer 200 already associated with the user of the external user ID, as described above. FIG. 7 illustrates an example of the stored content at this time. The example illustrated in FIG. 7 conforms to the example described with reference to FIGS. 3B and 3E. Specifically, the external user ID “A111111@Service1” that user “UA-1” uses for accessing Service 1 is stored in association with the printer ID “123-4567”. Similarly, the external user ID “B222222@Service2” that user “UB-2” uses for accessing Service 2 is stored in association with the same printer ID “123-4567”. The process executed by the advertisement provision server 100 in S4 is an example of the association process of the present disclosure.

The data stored in association with the printer ID is not limited to the external user IDs described above. That is, other identification information having a one-on-one correspondence with the external user ID may be used in place of the external user ID, provided that this information can identify the user associated with the external user ID. In this case, the other identification information is an example of the user identification information of the present disclosure. Thereafter, the advertisement provision server 100 transmits the settings screen information for displaying the settings screen 301B having the external user ID entered in the external user ID display field 305 to the terminal device 300 to be displayed on the display unit 301.

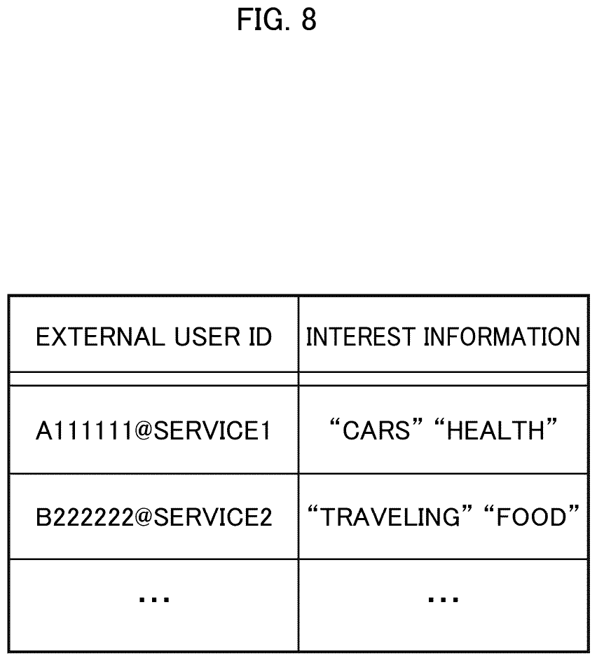

When the advertisement provision server 100 requests user interest information related to an external user ID from the user management server 400, in S5 the user management server 400 transmits user interest information for all users generated based on their behavioral information to the advertisement provision server 100 together with the corresponding external user IDs, as described above. The process of S5 may be executed periodically at fixed intervals, for example. Alternatively, the user management server 400 may transmit this information to the advertisement provision server 100 when detecting any changes in the stored data. FIG. 8 illustrates an example of associations established between user interest information and external user IDs at this time. The example illustrated in FIG. 8 conforms to the examples described above of the middle-aged male user and the female user in her 20s. That is, the external user ID “A111111@Service1” for user “UA-1”, who is a middle-aged man, is associated with the interest information “cars” and “health”, while the external user ID “B222222@Service2” for user “UB-2”, who is a woman in her 20s, is associated with the interest information “traveling” and “food”. The user interest information sent by the user management server 400 for all users is received by the advertisement provision server 100 in S10. The process executed in S10 is an example of the second receiving process of the present disclosure.

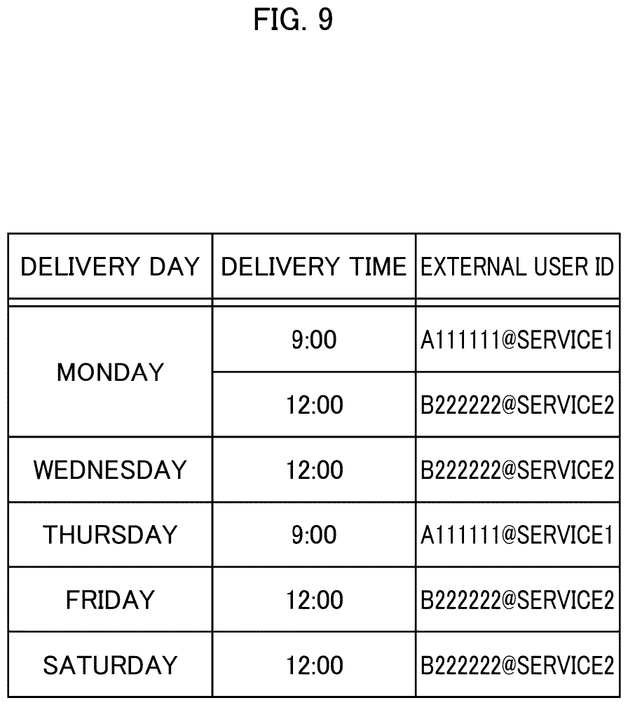

In S15 the advertisement provision server 100 determines whether an advertisement delivery time has arrived for any of the users for whom user interest information has been received in S10. In the present embodiment, advertisement delivery times, which are the times that advertisements are printed and provided to a user, are determined for each user in advance. For example, the external user IDs for all users, the printer IDs for the corresponding printers 200, and the corresponding advertisement delivery times are associated with each other and stored in the storage unit 115 as correlations. FIG. 9 illustrates an example of correlations between external user IDs and delivery times at this time. The example illustrated in FIG. 9 conforms to the example described with reference to FIGS. 3C and 3F. That is, the delivery times of every Monday and Thursday at 9:00 are associated with the external user ID “A111111@Service1” for user “UA-1”. The delivery times of every Monday, Wednesday, Friday, and Saturday at 12:00 are associated with the external user ID “B222222@Service2” for user “UB-2”. Thus, in S15 the advertisement provision server 100 determines whether the current time corresponds to any of the advertisement delivery times for any user.

If the current time does not correspond to an advertisement delivery time for any user (S15: NO), the advertisement provision server 100 returns to S10 and repeats the same process by again receiving user interest information for all users transmitted in S5. If the advertisement provision server 100 determines that the current time coincides with an advertisement delivery time for any user (S15: YES), the process advances to S20.

In S20 the advertisement provision server 100 identifies and acquires at least one external user ID for which the advertisement delivery time has arrived in S15. In this case, the arrival of the advertisement delivery time is an example of the predetermined rule of the present disclosure. In S20 the advertisement provision server 100 also identifies and acquires the printer ID corresponding to each external user ID identified and acquired in S15, which will be the delivery destination for advertisement images, based on the association illustrated in the example of FIG. 7. If the same advertisement delivery time is set for a plurality of users, the advertisement provision server 100 identifies a plurality of external user IDs for one advertisement delivery time. The process executed in S20 is an example of the determination process of the present disclosure.

Note that when there are multiple users to which advertisement images are to be delivered and, thus, a plurality of external user IDs to be processed, the method of setting external user IDs to be subjected to advertisement delivery is not limited to the method described above based on the arrival of the advertisement delivery time. For example, the advertisement provision server 100 may set external user IDs for which advertisement delivery should be executed sequentially and at suitable intervals in accordance with a rotating order predetermined for the plurality of external user IDs. In this case, the rotating order described above is an example of the predetermined rule of the present disclosure.

In S25 the advertisement provision server 100 identifies and acquires user interest information for the user corresponding to at least one external user ID obtained in S20 from the user interest information for all users received in S10. The process executed in S25 is an example of the acquisition process of the present disclosure.

### <Image Creation Process>

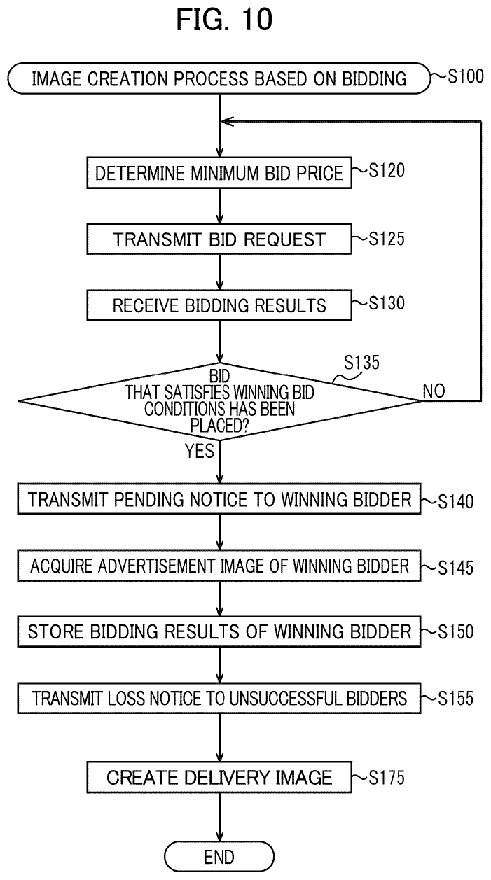

In S100 the advertisement provision server 100, in cooperation with the advertisement management server 500, performs a delivery image creation process for creating advertisement images to be printed by the printer 200 based on bids from advertisers. The control process executed by the control unit 110 of the advertisement provision server 100 in the delivery image creation process of S100 will be described with reference to the flowchart illustrated in FIG. 10.

In S120 of FIG. 10, the control unit 110 first determines a minimum bid price for soliciting bids for delivery of advertisement images. Minimum bid prices are uniquely determined in advance and stored in the storage unit 115, for example. In S120 the control unit 110 determines a corresponding minimum bid price based on the stored content in the storage unit 115.

In S125 the control unit 110 transmits a bid request to the advertisement management server 500. At this time, the minimum bid price determined in S120 and the user interest information acquired in S25 of FIG. 6 are transmitted to the advertisement management server 500 together with the bid request. In response to this bid request, the advertisement management server 500 holds an auction to solicit bids for an advertisement tailored to the user interest information received from the advertisement provision server 100. In the bid solicitation, the advertisement management server 500 requests advertisement images that satisfy predetermined conditions, including a condition that the advertisement is suited to the user interest information and a condition that the bid price be the minimum bid price or higher. Since the user interest information is generated based on behavioral information, as described above, an advertisement that is suited to the user interest information is equivalent to an advertisement that is suited to the behavioral information. Thus, the process executed in S125 is an example of the request process of the present disclosure.

Note that the control unit 110 may, through a bidding process, acquire an advertisement image suited to behavioral information rather than user interest information. In this case, the advertisement provision server 100 receives behavioral information for all users from the advertisement management server 500 or the user management server 400 in S5 described above and in S25 identifies and acquires behavioral information corresponding to the external user IDs whose delivery time has arrived. Further, in S125 the control unit 110 transmits the minimum bid price determined in S120 and the behavioral information acquired by the advertisement provision server 100 in S25 to the advertisement management server 500 together with a bid request. The advertisement management server 500 then holds an auction to solicit bids for advertisements tailored to the behavioral information received from the advertisement provision server 100. In this case, the advertisement management server 500 requests advertisement images that satisfy predetermined conditions including a condition that the advertisement is compatible with the behavioral information and a condition that the bid price be the minimum bid price or higher.

In S130 the control unit 110 receives bidding results from the advertisement management server 500 for the auction held in response to the bid request sent in S125. When a bid that satisfies the predetermined conditions stipulated in the bid request has been placed, the content of the received bidding results includes the advertisement image of the winning bidder. Information including an advertisement image received when a bid that satisfies the predetermined conditions stipulated in the bid request has been placed is an example of specific delivery information of the present disclosure. When no bids that satisfy the predetermined conditions stipulated in the bid request have been placed, such information is included in the content of the bidding results. The process executed in S130 is an example of the first receiving process of the present disclosure.

In S135 the control unit 110 determines based on the content received in S130 whether a bid that satisfies winning bid conditions has been placed. The winning bid conditions include a condition that the bid price is the highest, for example. The winning bid conditions may include other conditions that the predetermined conditions stipulated in the bid request are satisfied. When there is no bid that satisfies the winning bid conditions (S135: NO), the control unit 110 returns to the process in S120 described above and repeats the same process. When the process in S120 is executed after a NO determination in S135, the control unit 110 sets the minimum bid price lower than the previous minimum bid price, for example. On the other hand, when there is a bid that satisfies the winning bid conditions (S135: YES), the control unit 110 advances to S140.

In S140 the advertisement provision server 100 sends a “pending notice” to the advertisement management server 500 in order to notify the winning bidder, i.e., the advertiser who submitted the bid satisfying the winning bid conditions that the content of the bid will be adopted and stored for use without deletion. Upon receiving this pending notice, the advertisement management server 500 transfers the pending notice to the terminal device or the like of the winning bidder.

In S145 the control unit 110 identifies and acquires the advertisement image of the winning bidder. The advertisement image of the winning bidder is included in the bidding results received from the advertisement management server 500 in S130. In S150 the control unit 110 stores the bidding results by the winning bidder, i.e., the advertisement image and the like acquired in S145, in the storage unit 115.

In S155 the control unit 110 transmits a “loss notice” to the advertisement management server 500 to notify unsuccessful bidders, i.e., advertisers who have submitted bids not meeting the winning bidder conditions, that their bidding content will not be adopted because another bidder had the winning bid. Upon receiving this loss notice, the advertisement management server 500 transfers the notice to the terminal devices or the like of the unsuccessful bidders. Subsequently, the process advances to S175.

In S175 the control unit 110 creates a delivery image. In the delivery image the control unit 110 arranges the advertisement image of the winning bidder, and specifically information including the advertisement image in the bidding results received from the advertisement management server 500 in S130. Subsequently, the control unit 110 ends the process of FIG. 10. While the advertisement provision server 100 creates the delivery image in S175, the advertisement management server 500 instead may create the delivery image, and the advertisement provision server 100 may acquire this delivery image from the advertisement management server 500. Further, rather than creating a delivery image in S175, the control unit 110 may create print data for printing a delivery image in any of various page description languages.

### <Processes Following the Image Creation Process>

Returning to FIG. 6, after the advertisement provision server 100 completes the process of S100 described above, the process advances to S30. In S30 the advertisement provision server 100 transmits the delivery image created in S175 of the delivery image creation process of S100 to the printer 200 together with an instruction to print the delivery image. The process executed in S30 is an example of the delivery process of the present disclosure. The printer 200 receives the print instruction from the advertisement provision server 100 in S35 and generates printed matter by printing the delivery image included with the print instruction. The advertisement provision server 100 may also deliver the delivery image to the printer 200 through a relay device in S30. Alternatively, instead of delivering the delivery image to the printer 200, the advertisement provision server 100 may transmit a page description language description required for printing the delivery image or a link to the delivery image to the printer 200. When the printer 200 receives a link to a delivery image, the printer 200 accesses that link to acquire the delivery image and prints the acquired delivered image.

In S40 the advertisement provision server 100 transmits a billing notice to the advertisement management server 500 in order that the advertisement management server 500 can bill the advertiser, i.e., the winning bidder that has provided the advertisement image for the delivery image sent in S30, the corresponding fee for printing the advertisement. Upon receiving the billing notice from the advertisement provision server 100, in S45 the advertisement management server 500 performs a billing process to send a billing notice to the terminal device or the like of the winning bidder. Note that the processes in S40 and S45 to send the billing notice, and execute the billing process may be performed only after it is confirmed that the printed matter has been successfully generated in S30. In this case, if the printed matter has not been generated properly on the printer 200, the advertisement provision server 100 and advertisement management server 500 need not carry out the billing process at all, and if billed charges have already been settled, the full amount of this settlement may be refunded.

In S50 the advertisement provision server 100 stores the delivery image sent in S30 in the storage unit 115 in association with the printer ID of the corresponding printer 200, the external user ID of the corresponding user, the current time information, and the winning bid conditions met by the winning bidder of the advertisement image included in the delivery image. Subsequently, the process according to the sequence chart in FIG. 6 ends.

### Second Feature of the Embodiment

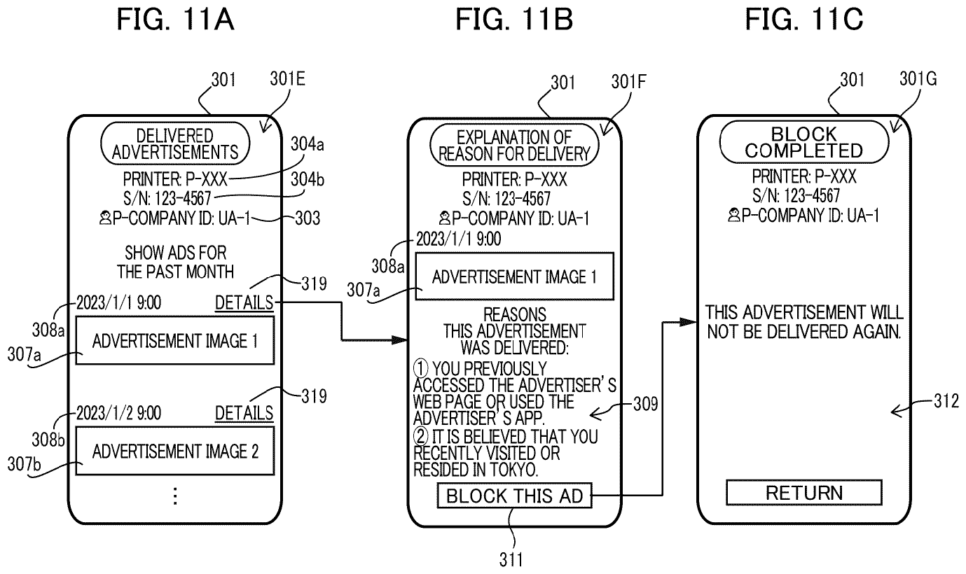

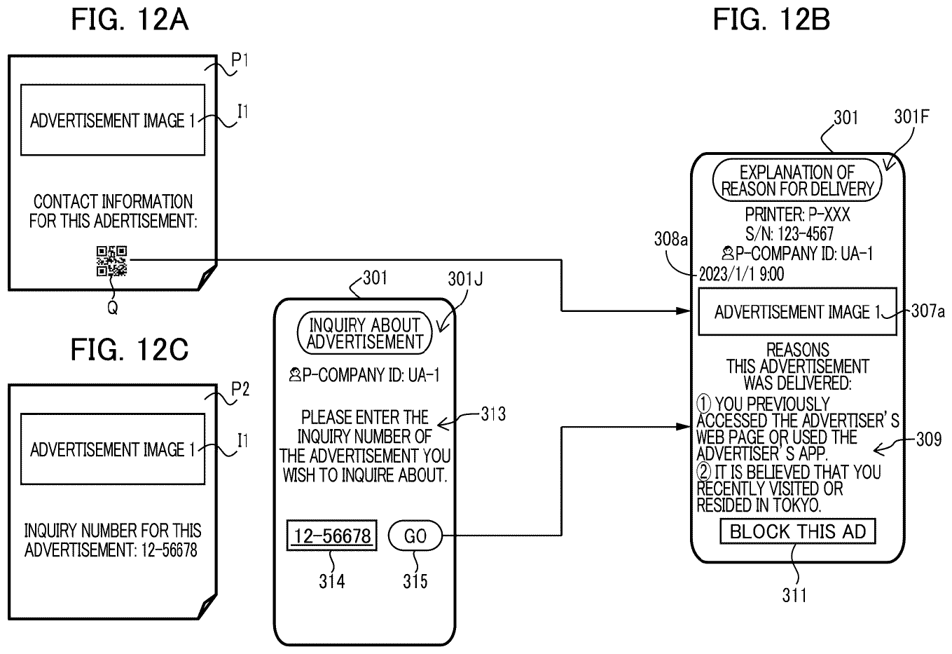

Another feature of the present embodiment is that after advertisements have been delivered as described above, users can make various inquiries about the delivered advertisements and can make requests to prevent further deliveries and the like. Examples of such processes will be described with reference to FIGS. 11A-12C.

### <Sample Process for Blocking Advertisement Delivery>

FIGS. 11A-11C illustrate an example of a process performed on the terminal device 300 for blocking future delivery of specific advertisements. As described above, the user first logs in to the web page of the advertisement delivery service using a browser running on the terminal device 300. When the user subsequently performs a suitable operation on the terminal device 300, for example, the control unit 310 issues a request to the advertisement provision server 100 for a delivered advertisement display screen 301E. In response to this request, the control unit 110 of the advertisement provision server 100 acquires delivered images, the printer ID, and the time information associated with the external user ID of user “UA-1”, who is currently logged in to the advertisement delivery service, from information that has been stored in the storage unit 115 in S50 of FIG. 6 described above. Here, the control unit 110 may acquire delivered images related to all logged in users, i.e., the delivered images that have been printed by the printer 200.

The control unit 110 of the advertisement provision server 100 creates screen information for displaying a delivered ad display screen 301E based on the acquired information and transmits this screen information for displaying the delivered advertisement display screen 301E to the terminal device 300. That is, the control unit 110 outputs a display signal to the terminal device 300 to display a list of the delivery images that have been printed by the printer 200 within a given period of time. Alternatively, the control unit 110 may output a display signal for displaying a list of all delivery images printed by the printer 200, without setting a particular time period. This process executed by the control unit 110 is an example of the list display process of the present disclosure. When the terminal device 300 receives the screen information for displaying the delivered advertisement display screen 301E from the advertisement provision server 100, the terminal device 300 displays the delivered advertisement display screen 301E on the display unit 301, as illustrated in the example of FIG. 11A. As in the above description, the delivered advertisement display screen 301E in FIG. 11A shows a sample display for user “UA-1” that includes “P-XXX” as the model number 304a of the printer; “123-4567” as the serial number 304b, which is the printer ID of the printer 200; and “UA-1” as the user ID 303 required to access the advertisement delivery service.

The delivered advertisement display screen 301E displayed on the display unit 301 includes a list of advertisement images that have been printed for user “UA-1” on the printer 200 during a prescribed period. In this example, the prescribed period is the past month. In other words, the delivered advertisement display screen 301E displays a list of advertisement images related to the external user ID “A111111@Service1” in accordance with the example described above. The displayed list includes each of the advertisement images 307a, 307b, . . . ; the corresponding delivery date and time information 308a, 308b, . . . ; and respective “Details” buttons 319.

As an example, the user performs operations on the terminal device 300 to specify the advertisement image 307a as the process target by operating the “Details” button 319 associated with the advertisement image 307a. When the control unit 310 receives this operation, the terminal device 300 transmits operation information to the advertisement provision server 100 indicating that the “Details” button 319 associated with the advertisement image 307a has been selected. Upon receiving operation information from the terminal device 300, the control unit 110 of the advertisement provision server 100 extracts winning bid conditions for the advertisement image 307a associated with the external user ID of user “UA-1” from among the information that has been stored in the storage unit 115 in S50 of FIG. 6 described above. The control unit 110 of the advertisement provision server 100 creates screen information for displaying a delivery reason description screen 301F based on the extracted winning bid conditions and sends the screen information for displaying the delivery reason description screen 301F to the terminal device 300. As an alternative, the control unit 110 of the advertisement provision server 100 may acquire the delivery reasons from the advertisement management server 500 and store these delivery reasons and may create screen information for displaying the delivery reason description screen 301F based on the stored results and transmit the screen information for displaying the delivery reason description screen 301F to the terminal device 300.

The control unit 110 outputs a display signal to the terminal device 300 for directing the terminal device 300 to display the delivery reason description screen 301F. This process executed by the control unit 110 is an example of the explanation display process of the present disclosure. Upon receiving this display signal and the screen information for displaying the delivery reason description screen 301F from the advertisement provision server 100, the control unit 310 changes the display on the display unit 301 to the delivery reason description screen 301F illustrated in FIG. 11B.

Note that the user may be allowed to operate a plurality of “Details” buttons 319 associated with a plurality of advertisement images simultaneously or collectively.

As an alternative to the method described above, the advertisement provision server 100 may store link information acquired from the advertisement management server 500 that provides a link to a web page of an external website. The web page includes the delivery reasons and a blocking button (described later). The advertisement provision server 100 may then transmit the link information to the terminal device 300. In this case, the user of the terminal device 300 accesses the web page on the external site by clicking on the link displayed based on the link information, whereby the terminal device 300 displays the reasons for delivery and the blocking button. The web page on the external site is a page provided on the advertisement management server 500 or a server provided separately from the advertisement management server 500.

The delivery reason description screen 301F in this example includes the advertisement image 307a, the delivery date and time information 308a, a reason explanation area 309, and a “Block this ad” button 311. The reason explanation area 309 includes text explaining why the displayed advertisement image 307a has been delivered in the past. The reasons given in this example are, “You previously accessed the advertiser's web page or used the advertiser's app” and “It is believed that you recently visited or resided in the designated area.” Here, “Tokyo” is used as an example of the designated area.

The “Block this ad” button 311 is provided for preventing any future delivery of the advertisement image displayed in the delivery reason description screen 301F, which in this example is the advertisement image 307a. When the user of the terminal device 300 operates the “Block this ad” button 311, the control unit 310 sends a delivery blocking request to the advertisement provision server 100 for prohibiting delivery of the corresponding advertisement image 307a. The advertisement provision server 100 receives this delivery blocking request from the terminal device 300. This delivery blocking request is an example of the delivery prohibition request of the present disclosure, and the process performed by the control unit 110 of receiving the delivery blocking request is an example of the request receiving process of the present disclosure.

Based on the delivery blocking request received from the terminal device 300, the advertisement provision server 100 stores information in the storage unit 115 in association with the external user ID. The stored information is information prohibiting delivery of the advertisement image 307a. This process executed by the control unit 110 is an example of the prohibition process of the present disclosure. In the above process, the advertisement provision server 100 may be configured to prohibit delivery of the same advertisement as the requested advertisement image 307a, to prohibit delivery of all advertisements in the same campaign as the advertisement image 307a, or to prohibit the delivery of all advertisements from the same advertiser.

Upon completion of this process, the advertisement provision server 100 generates screen information for displaying a block completion screen 301G and transmits the screen information for displaying the block completion screen 301G to the terminal device 300. When the terminal device 300 receives the screen information for displaying the block completion screen 301G from the advertisement provision server 100, the control unit of the terminal device 300 displays the block completion screen 301G on the display unit 301, as in the example of FIG. 11C. The block completion screen 301G includes a message 312 such as, “This advertisement will not be delivered again,” indicating that the process for blocking delivery of the advertisement image 307a requested by the user has been completed.

### <Another Sample Process for Blocking Advertisement Delivery>

FIGS. 12A-12C show another sample process flow on the terminal device 300 for blocking future delivery of specific advertisements. In this example, the user makes an inquiry using content included in the printed matter on which the advertisement image has been formed. FIG. 12A illustrates printed matter P1 for user “UA-1” that has been printed by the printer 200 in accordance with the example described above. As illustrated in the drawing, an advertisement image I1 corresponding to the advertisement image 307a described above has been formed on the printed matter P1. A two-dimensional barcode Q is also formed on the printed matter P1 for reference if the user wishes to inquiry about the advertisement image I1. The two-dimensional barcode Q is an example of the inquiry information of the present disclosure. The two-dimensional barcode Q represents information containing a URL for displaying a prescribed web page of the advertisement provision server 100.

For example, when the user reads the two-dimensional barcode Q with a scanner or camera provided in the terminal device 300, the control unit 310 receives the URL contained in the information represented by the two-dimensional barcode Q. As a result, the terminal device 300 accesses the URL and displays the same delivery reason description screen 301F described above in FIG. 11B on the display unit 301 of the terminal device 300, as shown in FIG. 12B. As in the previous example, the delivery reason description screen 301F includes the advertisement image 307a corresponding to the advertisement image I1, the delivery date and time information 308a and reason explanation area 309 associated with the advertisement image 307a, and the “Block this ad” button 311.

The example illustrated in FIG. 12C shows another printed matter P2 for user “UA-1” that has been printed on the printer 200. As with the printed matter P1 described above, the printed matter P2 in this drawing includes the advertisement image I1 corresponding to the advertisement image 307a. An inquiry number “12-56678” is also formed on the printed matter P2 for reference when the user wishes to inquire about the advertisement image I1. This inquiry number is also an example of the inquiry information of the present disclosure.

At this time, the user can perform operations on the terminal device 300 to access the advertisement provision server 100 and display an advertisement inquiry screen 301J on the display unit 301 of the terminal device 300, for example. The advertisement inquiry screen 301J includes a message 313, such as “Please enter the inquiry number of the advertisement you wish to inquire about”; an inquiry number entry field 314 in which an inquiry number can be manually inputted; and a “Go” button 315. By performing operations on the terminal device 300 to input the inquiry number “12-56678” provided on the printed matter P2 into the inquiry number entry field 314 and pressing the “Go” button 315, the user can display the delivery reason description screen 301F illustrated in FIG. 12B on the display unit 301, as in the previous method.

When the user presses the “Block this ad” button 311 in FIG. 12B through an operation on the terminal device 300, as in the previous description, the control unit 310 sends a delivery blocking request to the advertisement provision server 100 for prohibiting delivery of the advertisement image 307a, i.e., for prohibiting printing of the advertisement image I1, and the advertisement server 100 receives the delivery blocking request. The delivery blocking request is an example of the delivery prohibition request of the present disclosure, and the process of receiving the delivery blocking request performed by the control unit 110 of the advertisement server 100 is an example of the request receiving process of the present disclosure. Upon receiving the delivery blocking request from the terminal device 300, the control unit 110 of the advertisement provision server 100 stores information in the storage unit 115 in association with the external user ID for user “UA-1”. The stored information is information prohibiting delivery of the advertisement image 307a. This process executed by the control unit 110 is an example of the prohibition process of the present disclosure. Upon completion of this blocking process, the terminal device 300 changes the display on the display unit 301 to the same block completion screen 301G illustrated in FIG. 11C.

After information for prohibiting the delivery of an advertisement image has been stored in the storage unit 115 in response to a blocking request from the terminal device 300, the advertisement provision server 100 instructs the advertisement management server 500 to perform a corresponding process for the blocking request and modifies the bid request and winning bid conditions in the advertisement provision server 100 based on this instruction. The same process described above may be performed by the terminal device 300 transmitting the blocking request directly to the advertisement management server 500 or an external website.

### Effects of the Embodiment

In the embodiment described above, the storage unit 115 of the advertisement provision server 100 stores association information associating printer IDs with external user IDs that identify users for the purpose of logging in to an external service using a prescribed terminal device other than the printer 200, such as the terminal device 300.

Based on the association information stored in the storage unit 115, in S125 the control unit 110 transmits a bid request to the advertisement management server 500 requesting an advertisement image of a winning bidder that meets predetermined conditions. One predetermined condition is that the advertisement image is suited to the behavioral information and/or user interest information corresponding to the external user ID, which is associated with the printer ID of the printer 200 serving as the destination of delivery (delivery destination device). In response to the bid request, the advertisement provision server 100 receives the advertisement image from the advertisement management server 500 in S130 and transmits the received advertisement image to the printer 200 in S30, whereby the printer 200 prints a delivery image corresponding to the advertisement image of the winning bidder.

According to the present embodiment, an external user ID associated with a printer ID is used to receive an advertisement image that is suited to user information such as behavioral information and user interest information and to print a delivery image corresponding to this advertisement image. Hence, according to the present embodiment, delivery images suited to user information for each user can be printed without having to manage information on the users' preferences, interests, and the like for each printer 200, as is the case with the conventional methods.

A particular feature of the embodiment is that in S20 the control unit 110 of the advertisement provision server 100 acquires the printer ID for the printer 200 serving as the destination of delivery and the external user IDs associated with this printer ID. In this case, the predetermined conditions include the condition that the advertisement image is suited to behavioral information associated with at least one of the acquired external user IDs. The control unit 110 requests the advertisement image of a winning bidder that meets the predetermined conditions, including the condition that the advertisement image is suited to such behavioral information, through a bid request sent in S125 and receives the advertisement image of the winning bidder from the advertisement management server 500 in S130.

According to the present embodiment, advertisement images suited to behavioral information of users that use the printer 200 serving as the destination of delivery can be printed.

A particular feature of the present embodiment is that when a plurality of users share one printer 200, one printer ID is associated with a plurality of external user IDs. In S20 the control unit 110 determines one external user ID from among the plurality of external user IDs in accordance with predetermined rules. Through a bid request in S125, the control unit 110 requests an advertisement image of a winning bidder that meets prescribed conditions, including a condition that the advertisement image is suited to behavioral information for the user corresponding to the external user ID determined in S20, and receives the advertisement image of the corresponding winning bidder from the advertisement management server 500 in S130.

In the present embodiment, one user is determined based on the predetermined rules from among a plurality of users of the printer 200 serving as the delivery destination, and only an advertisement image suited to the behavioral information for the determined user is printed. This method protects the privacy of users sharing a single printer 200 since advertisement images suited to the behavioral information of multiple users sharing the printer 200 are never printed at the same time. Such privacy protection is particularly significant since printed matter printed by the printer 200 is not always collected by the user immediately after being printed but may be left on the printer 200 for a while after printing.

Another feature of the present embodiment is that in S25 of FIG. 6 the advertisement provision server 100 acquires behavioral information corresponding to at least one external user ID determined in S20 or user interest information based on that behavioral information. The aforementioned predetermined conditions include a condition that the advertisement image is suited to this behavioral information or the user interest information acquired in S25. The control unit 110 transmits a bid request in S125 requesting such advertisement image of a winning bidder that meets the predetermined conditions, including the condition that the advertisement image is suited to the behavioral information, and receives the corresponding advertisement image from the advertisement management server 500 in S130.

According to the present embodiment, an advertisement image suited to behavioral information or interest information of a user using the printer 200 as the delivery destination can be printed.

Another feature of the present embodiment is that in S10 of FIG. 6 the control unit 110 receives behavioral information or user interest information corresponding to all external user IDs associated with a single printer ID from the advertisement management server 500. In S25 the control unit 110 extracts behavioral information or user interest information corresponding to at least one of the external user IDs from among all of the received behavioral information or user interest information and uses this extracted information to receive the advertisement image of a winning bidder from the advertisement management server 500.

According to the present embodiment, behavioral information or user interest information pertaining to a user of the printer 200 can be extracted from the behavioral information or user interest information pertaining to all users acquired in S10, and an advertisement image suited to this information can be printed.

Another feature of the present embodiment is that the content of printed advertisement images can be displayed in a list, as in the delivered advertisement display screen 301E illustrated in FIG. 11A. When the user specifies at least one of the advertisement images displayed in the list, an explanation of why the specified advertisement images have been delivered is displayed in the delivery reason description screen 301F illustrated in FIG. 11B.

According to the present embodiment, the user can learn the reasons why the printed advertisement images have been delivered.

Another feature of the present embodiment is that when the user no longer wishes to print an advertisement image after learning through the delivery reason description screen 301F the reason why the advertisement image has been delivered, the user can perform an operation to press the “Block this ad” button 311. As a result, the control unit 310 performs a control process to prohibit further delivery of the advertisement image associated with that operation.

According to the present embodiment, delivery of an advertisement image the user no longer wishes to receive can be prohibited in accordance with the user's wishes.

Another feature of the present embodiment is that the printed matter P1 or P2 illustrated in FIG. 12A or FIG. 12C includes a two-dimensional barcode Q or an inquiry number. When the user wishes to halt printing of the advertisement image I1 included in the printed matter P1 or P2, the user operates the “Block this ad” button 311 in the delivery reason description screen 301F displayed in response to the user scanning the two-dimensional barcode Q or entering the inquiry number included in the printed matter P1 or P2. As a result, the control unit 310 can perform control to prohibit further delivery of the advertisement image associated with that operation.

According to the present embodiment, the delivery of advertisement images that the user no longer wishes to have printed can be prohibited according to the user's intention.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below, wherein like parts and components to those in the above embodiment are designated with the same reference numerals to avoid duplicating description:

### (1) Setting Matching Conditions for Advertisement Delivery in Advance

FIGS. 13A-13H show the flow of a process according to the present variation for registering an external user ID and subsequently setting matching conditions for that user. This process corresponds partially to FIGS. 3A-3F of the above embodiment.

As in FIGS. 2A-2C described above, FIGS. 13A-13D show a case in which the printer 200 having printer ID “123-4567” is used by user “UA-1”.

In FIGS. 13A-13C, each of the settings screens 301A, 301B, and 301C is displayed on the display unit 301 as described above, and the same process is performed according to the aforementioned operations. For example, when the user performs suitable operations on the terminal device 300 while the settings screen 301C illustrated in FIG. 13C is displayed, a matching settings screen 301D illustrated in FIG. 13D is displayed on the display unit 301.

The matching settings screen 301D includes a delivery category specification field 316 for specifying categories of advertisements the user wishes to receive for delivery, a rejected category specification field 317 for specifying categories of advertisements the user wishes to exclude from delivery, and a use specification field 318 for selecting the intended use of the printer 200.

In the example of FIG. 13D, the delivery category specification field 316 has a plurality of suggested categories including “Shopping,” “TV,” “Sports,” and “Games.” In this example, user “UA-1” has indicated a desire to receive advertisement deliveries in the categories of “TV” and “Sports.” The control unit 310 of the terminal device 300 transmits information on the user's preferred categories to the advertisement provision server 100. Upon receiving information on categories from the terminal device 300, the advertisement provision server 100 stores the category information in the storage unit 115 in association with the external user ID of user “UA-1”. As a result, the control unit 110 of the advertisement provision server 100 controls the delivery of advertisements for user “UA-1” so that advertisements in these categories are included as the above winning bid conditions in addition to the conditions that advertisements are compatible with the user interest information and that the bid price is at least as high as the minimum bid price.

In the example of FIG. 13D, the rejected category specification field 317 has a plurality of suggested categories including “Movies,” “Cosmetics,” “Adult,” and “Music.” In this example, user “UA-1” indicates a preference to refuse the delivery of advertisements in the “Cosmetics” category. The control unit 310 of the terminal device 300 transmits information on the user's rejected categories to the advertisement provision server 100. Upon receiving this category information from the terminal device 300, the advertisement provision server 100 stores the category information in the storage unit 115 in association with the external user ID of user “UA-1”. As a result, the control unit 110 of the advertisement provision server 100 controls the delivery of advertisements for “UA-1” so that advertisements not being in the above categories is included as one of the above winning bid conditions in addition to the conditions that the advertisement is suited to the user interest information and that the bid price is at least as high as the minimum bid price. The types of categories provided in the delivery category specification field 316 and rejected category specification field 317 may be completely different from each other, as in the above example, may be exactly the same, or may include some shared categories. If the categories in the specification fields 316 and 317 can be selectively displayed in the matching settings screen 301D, the displayed categories may be selected or narrowed to reflect each user's behavioral information or interest information.

In the example of FIG. 13D, the use specification field 318 offers “Home use” and “Office use” as categories for the intended use of the printer 200. In this example, user “UA-1” has selected “Home use” as the intended application. The intended use is an example of the printing-related information of the present disclosure. As a result of this selection, the control unit 310 of the terminal device 300 transmits information on the intended use selected by the user to the advertisement provision server 100. Upon receiving use information from the terminal device 300, the advertisement provision server 100 stores this use information in the storage unit 115 in association with the external user ID of user “UA-1”. The control unit 110 of the advertisement provision server 100 controls the delivery of advertisements for user “UA-1” such that advertisements being for home use rather than office use is included as one of the above conditions for a winning bid in addition to the conditions that advertisement image is suitable to the user interest information that the bid price is at least as high as the minimum bid price.

In addition to the above conditions, winning bid conditions may include conditions that the advertisement image is compatible with printing-related information for the printer 200, such as the size of paper currently loaded in the paper tray, monochrome/color printing options, the quantity of ink in the cartridges 285, and the number of sheets available for printing.

In the above case, when the advertisement provision server 100 sends a bid request to the advertisement management server 500 in S125 of FIG. 10 described above, the predetermined conditions that must be met by the advertisement image of a winning bidder include the condition that the advertisement image is suitable to the printing-related information for the printer 200 corresponding to the printer ID determined in S20. In other words, the bid request that the advertisement provision server 100 sends to the advertisement management server 500 includes category information based on the delivery category specification field 316, rejected category specification field 317, and use specification field 318. Therefore, the advertisement image of the winning bidder received from the advertisement management server 500 will be compatible with the intended use of the printer 200, as well as the paper size, monochrome/color printing options, ink quantities, and number of sheets available for printing in the printer 200. As a result, the control unit 110 of the advertisement provision server 100 will receive only an advertisement image suited to the above conditions on the printer 200 side from the advertisement management server 500 and can transmit this advertisement image to the printer 200 for printing. Note that the advertisement provision server 100 need not include category information with a bid request sent to the advertisement management server 500 as described above, but instead may filter the bidding results received from the advertisement management server 500 to extract an advertisement image that satisfies this category information. The same applies to the example in FIGS. 13E-13H described below.

In FIGS. 13E-13G, the same process described above is performed to display each of the settings screens 301A, 301B, and 301C on the display unit 301. The user displays the matching settings screen 301D illustrated in FIG. 13H on the display unit 301 by performing a suitable operation in the settings screen 301C illustrated in FIG. 13G, for example. As described above, this matching settings screen 301D includes the delivery category specification field 316, rejected category specification field 317, and use specification field 318.

In the example of FIG. 13H, user “UB-2” has specified the categories “Shopping,” “TV,” and “Games” in the delivery category specification field 316 as categories for which the user wishes to have advertisements delivered, has specified the category “Adult” in the rejected category specification field 317 as a category for which the user wishes to refuse advertisements delivered, and has selected “Home use” in the use specification field 318 as the intended use of the printer 200. As a result, the control unit 110 of the advertisement provision server 100 controls the delivery of advertisements for user “UB-2” so that the above specifications and selections are reflected in the winning bid conditions.

As described above, each user is not limited to logging in to the advertisement delivery service using the user's own terminal device 300 to perform various settings in the delivery category specification field 316, rejected category specification field 317, and use specification field 318 for him or herself That is, one user authorized to represent a plurality of other users may be allowed to make settings in the above settings fields 316, 317, and 318 for the other users while logged in to the advertisement delivery service.

(2) Process Performed when an External User ID is not Valid

An external user ID that was valid at the time of initial setup may subsequently become unusable due to the user unsubscribing from the external service or the user performing operations on the external service to cancel the association with the advertisement provision server 100 or the like. When such a case is detected in this variation, the control unit 110 of the advertisement provision server 100 performs control to stop delivering advertisements for the user or to notify the user of this issue by outputting an error signal or the like.

Detection of an invalid external user ID may be achieved in various ways. For example, the advertisement provision server 100 may receive an error signal from the advertisement management server 500. Alternatively, it is sufficient for the advertisement provision server 100 to check the validity of the external user ID periodically with the server of the external service.

In order to notify the user of this situation when it occurs, the terminal device 300 or printer 200 may be placed in a state where the association between the printer 200 and the external user ID can be suitably displayed and confirmed thereon, and if the advertisement provision server 100 detects an invalid external user ID, the content of these displays may be changed to a prescribed warning status. The printer 200 may also be configured to display the prescribed warning upon receiving account suspension information from the advertisement provision server 100.

### (3) Other Variations

While the advertisement provision server 100 is described above as a standalone device, a plurality of devices may operate in cooperation with each other to implement the functions of the advertisement provision server 100.

The advertisement provision server 100 described above acquires an advertisement image that satisfies predetermined conditions, such as a condition that the advertisement image is suited to the user's behavioral information or interest information, through a bidding process, but the method of obtaining the advertisement image is not limited to this. The advertisement provision server 100 may acquire an advertisement image that satisfies these predetermined conditions through other suitable methods. Other methods may include acquiring an advertisement image that is suited to user information including the gender, age, place of residence, occupation, place of work, annual income, and family structure of the user using the external service, for example.

In the above description, advertising information is used as an example of the information managed by the advertisement management server 500 and distributed to the advertisement provision server 100, but the information being managed and distributed may be other service content. Examples of such service content may be manga, images from novels, movies, thumbnail images from movies, and the like.

The flowcharts illustrated in FIGS. 6 and 10 in the above description do not limit the present disclosure to the steps indicated therein. Steps may be added or deleted, or their order may be rearranged, without departing from the spirit and technical ideas of the disclosure.

In addition to what has already been described, the methods according to the embodiment and its variations described above may be used in suitable combinations.

In addition, although not illustrated individually, the present invention may be implemented with various modifications without departing from the spirit of the invention.

What is claimed is:

1. An information delivery system comprising:
a delivery destination device; and
a delivery provision server comprising:
a communication interface configured to receive delivery information from a delivery management server, the delivery management server being configured to manage the delivery information;
a memory configured to store association information associating user identification information with delivery destination identification information, the delivery destination identification information identifying the delivery destination device as a delivery destination of the delivery information, the user identification information identifying a user and being used for the user logging in to a user account for an external service using a terminal device other than the delivery destination device; and
a controller configured to perform:
a request process transmitting a request for specific delivery information to the delivery management server via the communication interface, the specific delivery information being the delivery information satisfying a predetermined condition, the predetermined condition including a requirement that the delivery information be suited to user information corresponding to the user identification information which is associated with the delivery destination identification information by the association information stored in the memory;
a first receiving process receiving, in response to the request transmitted in the request process, the specific delivery information from the delivery management server via the communication interface; and
a delivery process transmitting an output instruction to the delivery destination device corresponding to the delivery destination identification information via the communication interface, the output instruction instructing the delivery destination device to perform output based on the specific delivery information.

2. The information delivery system according to claim 1,
wherein the delivery destination device is a printer configured to form an image on a sheet, and
wherein in the delivery process, the controller transmits a print instruction to the printer as the output instruction, the print instruction instructing the printer to perform printing based on the specific delivery information.

3. The information delivery system according to claim 2,
wherein the predetermined condition includes a requirement that the delivery information be suited to printing-related information for the printer.

4. The information delivery system according to claim 1,
wherein the user information includes user behavioral information indicating behavior of the user while the user is logged in to the external service, and
wherein the predetermined condition includes a requirement that the delivery information be suited to the user behavior information corresponding to the user identification information which is associated with the delivery destination identification information by the association information stored in the memory.

5. The information delivery system according to claim 4,
wherein the association information associates at least one set of user identification information with the delivery destination identification information, the at least one set of user identification information corresponding to respective ones of at least one user,
wherein the controller is configured to further perform:
a determination process determining the delivery destination identification information of the delivery destination device and the at least one set of user identification information corresponding to the delivery destination identification information, and
wherein the predetermined condition includes a requirement that the delivery information be suited to the user behavioral information corresponding to each set of the at least one set of user identification information determined in the determination process.

6. The information delivery system according to claim 5,
wherein in the determination process, the controller determines one set of user identification information from among the at least one set of user identification information in accordance with a predetermined rule.

7. The information delivery system according to claim 1,
wherein the association information associates a plurality of sets of user identification information with the delivery destination identification information, the plurality of sets of user identification information corresponding to respective ones of a plurality of users,
wherein the controller is configured to further perform:
a determination process determining the delivery destination identification information of the delivery destination device and at least one set of user identification information associated with the delivery destination identification information by the association information stored in the memory; and
an acquisition process acquiring at least one set of user information corresponding to respective ones of the at least one set of user identification information determined in the determination process, each set of the at least one set of user information being one of user behavioral information and user interest information for a corresponding user identified by a corresponding one set of the at least one set of user identification information, the user behavioral information indicating behavior of the corresponding user while the corresponding user is logged in to the external service, the user interest information specifying at least one item of interest to the corresponding user, and
wherein the predetermined condition includes a requirement that the delivery information be suited to each set of the at least one set of user information acquired in the acquisition process.

8. The information delivery system according to claim 7,
wherein the controller is configured to further perform:
a second receiving process receiving a plurality of sets of user information from a user management server, the user management server being configured to manage each of the plurality of sets of user information, the plurality of sets of user information corresponding to respective ones of the plurality of sets of user identification information associated with the delivery destination identification information by the association information stored in the memory, and
wherein in the acquisition process, the controller acquires the at least one set of user information corresponding to the at least one set of user identification information from among the plurality of sets of user information received in the second receiving process.

9. The information delivery system according to claim 1,
wherein the controller is configured to further perform:
a list display process outputting a first display signal to display on a display a list of one or more delivery images based on the specific delivery information, the one or more delivery images having been outputted from the delivery destination device in accordance with the output instruction; and
an explanation display process displaying on the display an explanation of a reason why at least one delivery image of the one or more delivery images has been delivered.

10. The information delivery system according to claim 9,
wherein the controller is configured to further perform:
a request receiving process receiving a delivery prohibition request for prohibiting delivery of the at least one delivery image for which the explanation of the reason has been displayed; and
a prohibition process prohibiting, in response to the delivery prohibition request, the at least one delivery image from being further delivered in the delivery process.

11. The information delivery system according to claim 1,
wherein the controller is configured to further perform:
a request receiving process receiving a delivery prohibition request for prohibiting delivery of a delivery image using inquiry information, the delivery image having been outputted from the delivery destination device in accordance with the output instruction, the inquiry information being information used to inquire about the delivery image and having been outputted together with the delivery image; and
a prohibition process prohibiting, in response to the delivery prohibition request, the delivery image from being further delivered in the delivery process.

12. The information delivery system according to claim 1,
wherein when the user identification information stored in the memory becomes invalid for logging in to the user account for the external service, the controller performs one of skipping the delivery process and outputting an error signal.

13. A delivery provision server comprising:
a communication interface configured to receive delivery information from a delivery management server, the delivery management server being configured to manage the delivery information;
a memory configured to store association information associating user identification information with delivery destination identification information, the delivery destination identification information identifying a delivery destination device as a delivery destination of the delivery information, the user identification information identifying a user and being used for the user logging in to a user account for an external service using a terminal device other than the deliver destination device; and
a controller configured to perform:
a request process transmitting a request for specific delivery information to the delivery management server via the communication interface, the specific delivery information being the delivery information satisfying a predetermined condition, the predetermined condition including a requirement that the delivery information be suited to user information corresponding to the user identification information which is associated with the delivery destination identification information by the association information stored in the memory;
a receiving process receiving, in response to the request transmitted in the request process, the specific delivery information from the delivery management server via the communication interface; and
a delivery process transmitting an output instruction to the delivery destination device corresponding to the delivery destination identification information via the communication interface, the output instruction instructing the delivery destination device to perform output based on the specific delivery information.

14. A delivery provision server comprising:
a memory;
a communication interface configured to transmit delivery information to a delivery destination device; and
a controller configured to perform:
a transmission process transmitting settings screen information for displaying a settings screen to a terminal device other than the delivery destination device via the communication interface, the settings screen being used for configuring a setting for delivery of the delivery information;
an association process storing, in response to an input of a user account for an external service being received through the settings screen displayed on the terminal device, association information associating user identification information corresponding to the user account with delivery destination identification information in the memory, the delivery destination identification information identifying the delivery destination device as a delivery destination of the delivery information, the user identification information identifying a user and being used for the user logging in to the user account for the external service using the terminal device; and
a delivery process transmitting specific delivery information to the delivery destination device corresponding to the delivery destination identification information via the communication interface, the specific delivery information being the delivery information satisfying a predetermined condition, the predetermined condition including a requirement that the delivery information be suited to user information corresponding to the user identification information which is associated with the delivery destination identification information by the association information stored in the memory.

15. A terminal device comprising:
a communication interface communicable with a delivery provision server configured to provide delivery information to a delivery destination device;
a display; and
a controller configured to perform:
an acquisition process acquiring settings screen information for displaying a settings screen from the delivery provision server via the communication interface, the settings screen being used for configuring a setting for delivery of the delivery information;
a display process displaying on the display the settings screen based on the settings screen information acquired in the acquisition process; and
a reception process receiving an input of a user account for an external service through the settings screen displayed on the display in the display process, the delivery provision server being configured to provide specific delivery information to the delivery destination device, the specific delivery information being the delivery information satisfying a predetermined condition, the predetermined condition including a requirement that the delivery information be suited to user information corresponding to user identification information, the user identification information identifying a user and being used for the user logging in to the user account for the external service.
